(19) United States
(12) Patent Application Publication
(10) Pub. No.: US 2016/0357013 A1
(43) Pub. Date: Dec. 8, 2016

(54) DISPLAY APPARATUS

(71) Applicant: OLYMPUS CORPORATION, Tokyo (JP)

(72) Inventors: Daichi WATANABE, Tokyo (JP); Kanto MIYAZAKI, Tokyo (JP)

(73) Assignee: OLYMPUS CORPORATION, Tokyo (JP)

(21) Appl. No.: 15/242,304

(22) Filed: Aug. 19, 2016

Related U.S. Application Data
(63) Continuation of application No. PCT/JP2015/000826, filed on Feb. 20, 2015.

(30) Foreign Application Priority Data
Mar. 12, 2014 (JP) 2014-049271

(51) Int. Cl. G02B 27/00; G02B 1/18; G02B 1/11; G03B 21/14; G02B 6/12

(52) U.S. Cl. CPC G02B 27/0081; G03B 21/14; G02B 6/12004; G02B 1/11; G02B 1/18; G03B 21/208

(57) ABSTRACT

A display apparatus includes a light guide that propagates image light while totally reflecting the image light, an optical system that introduces the image light into the light guide, a light beam extractor that emits the image light propagating in the light guide from an observer-side surface of the light guide along an extent of propagation of the image light, and a window member facing the observer-side surface of the light guide with a gap therebetween.

### CROSS-REFERENCE TO RELATED APPLICATION

The present application is a Continuing Application based on International Application PCT/JP2015/000826 filed on Feb. 20, 2015, which in turn claims priority to Japanese Patent Application No. 2014-049271 filed on Mar. 12, 2014, the entire disclosure of these earlier applications being incorporated herein by reference.

### TECHNICAL FIELD

This disclosure relates to a display apparatus that displays an image by enlarging an exit pupil.

### BACKGROUND

In order, for example, to allow an observer to observe images at a variety of positions, one known display apparatus enlarges the exit pupil of an optical projection system (for example, see JP 5218438 B2 (PTL 1)). The display apparatus disclosed in PTL 1 introduces, into a light guide, image light to be displayed and guides the image light while repeatedly subjecting the image light to total reflection within the light guide. Total reflection refers to the phenomenon by which, when light enters a medium with a smaller refractive index from a medium with a larger refractive index, the incident light does not pass through the interface but rather is completely reflected. While being guided through the light guide, the image light is sequentially reflected at a plurality of beam splitter surfaces provided in the light guide, and the image light reflected at each beam splitter surface is emitted from the surface of the light guide. As a result, image light is emitted from nearly the entire surface of the light guide, the exit pupil of image light incident on the light guide is expanded, and an image can be observed at any position on the surface of the light guide.

### CITATION LIST

### Patent Literature

PTL 1: JP 5218438 B2

### SUMMARY

A display apparatus according to this disclosure includes a light guide configured to propagate image light while totally reflecting the image light;

an optical system configured to introduce the image light into the light guide;

a light beam extractor configured to emit the image light propagating in the light guide from an observer-side surface of the light guide along an extent of propagation of the image light; and

a window member facing the observer-side surface of the light guide with a gap therebetween.

The gap may be 700 nm or greater to 1 mm or less.

The window member may be formed by a parallel flat plate.

The window member may have a refractive power.

The window member may include an AR film.

The window member may include a fingerprint anti-adhesive film.

The window member may include a water repellent film.

The display apparatus may include a plurality of spacers disposed between the light guide and the window member at a periphery of the light guide, and

the light guide may be pressed elastically to the spacers.

The spacers may be partially in point contact or line contact with the light guide.

The spacers may have a surface roughness Rv of 0.6 μm or greater at the light guide side of the spacers.

The spacers may be made of metal.

The spacers may be made of plastic.

### BRIEF DESCRIPTION OF THE DRAWINGS

In the accompanying drawings:

FIG. 1 is a perspective view of a display apparatus according to Embodiment 1;

FIG. 2A schematically illustrates the structure of the optical image projection system in FIG. 1 as seen from the y-direction;

FIG. 2B schematically illustrates the structure of the optical image projection system in FIG. 2A as seen from the x-direction;

FIG. 3 is a perspective view displaying the structural components of the pupil enlarging optical system in FIG. 1 separated from each other;

FIG. 4 is a perspective view displaying the structural components of the first optical propagation system in FIG. 3 separated from each other;

FIG. 5 is a side view of the first optical propagation system;

FIG. 6 is a graph illustrating the reflectance versus the wavelength of a thin film, in order to illustrate the property of the spectral curve of the thin film shifting along the wavelength direction depending on the angle of incidence;

FIG. 7 is a graph illustrating the transmittance as a function of distance from an area of incidence on a first polarizing beam splitter film;

FIG. 8 is a perspective view displaying the structural components of the second optical propagation system in FIG. 3 separated from each other;

FIG. 9 illustrates the arrangement of the parallel flat plate that is a window member in FIG. 1;

FIG. 10 is a partial enlargement illustrating the relationship between the gap in FIG. 9 and the angle of incidence θ of the second light guide;

FIG. 11 illustrates the results of simulating reflectance at the angle of incidence θ versus the distance d of the gap in FIG. 10;

FIG. 12 is a partial schematic diagram illustrating an example of holding the parallel flat plate in FIG. 9;

FIG. 13 illustrates the main structure of a display apparatus according to Embodiment 2;

FIG. 14 schematically illustrates the main structure of a display apparatus according to Embodiment 3; and

FIG. 15 schematically illustrates the main structure of a display apparatus according to Embodiment 4.

### DETAILED DESCRIPTION

The following describes embodiments with reference to the drawings.

### Embodiment 1

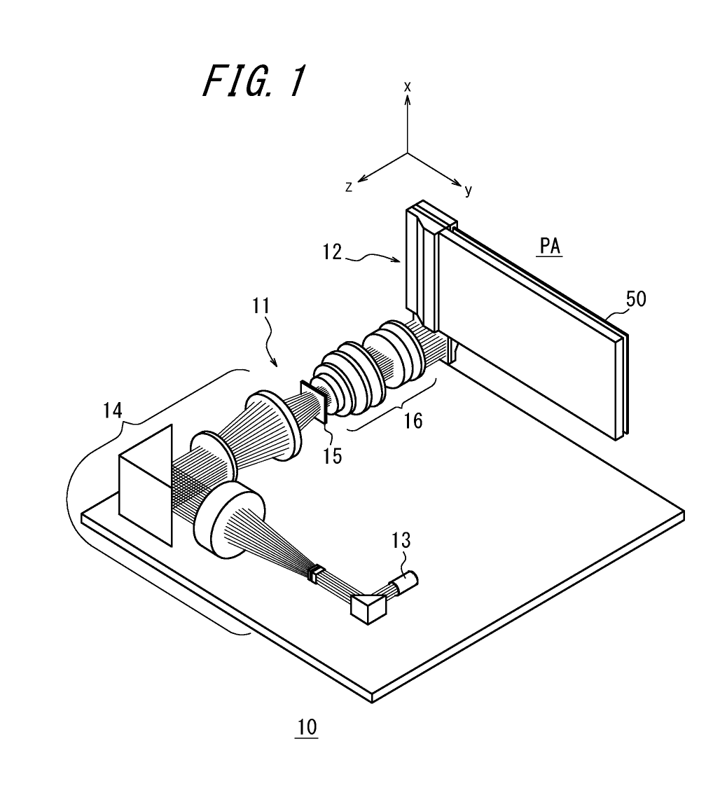

FIG. 1 is a perspective view of a display apparatus according to Embodiment 1. The display apparatus 10 illustrated in FIG. 1 includes an optical image projection system 11, a pupil enlarging optical system 12, and a parallel flat plate 50 that is a window member. In this embodiment, the direction along the optical axis of the optical image projection system 11 is treated as the z-direction, and the directions that are perpendicular to the z-direction and perpendicular to each other are treated as the x-direction (first direction) and the y-direction (second direction). In FIG. 1, the upward direction is the x-direction. Furthermore, near the pupil enlarging optical system 12 in FIG. 1, the direction diagonally downward to the right is the y-direction, and the direction diagonally downward to the left is the z-direction.

The optical image projection system 11 projects image light corresponding to an image to infinity. The image light projected by the optical image projection system 11 enters the pupil enlarging optical system 12, which enlarges the exit pupil and emits the result. By aligning the eye with any position in a projection area PA of the enlarged exit pupil, the observer can observe an image.

Next, the structure of the optical image projection system 11 is described. The optical image projection system 11 includes a light source 13, an optical illumination system 14, a transmissive chart 15, and an optical projection system 16. The light source 13 is driven by a light source driver (not illustrated) and emits a laser as illumination light using power supplied by a battery (not illustrated). The wavelength of the laser is in the visible light region and may, for example, be 532 nm.

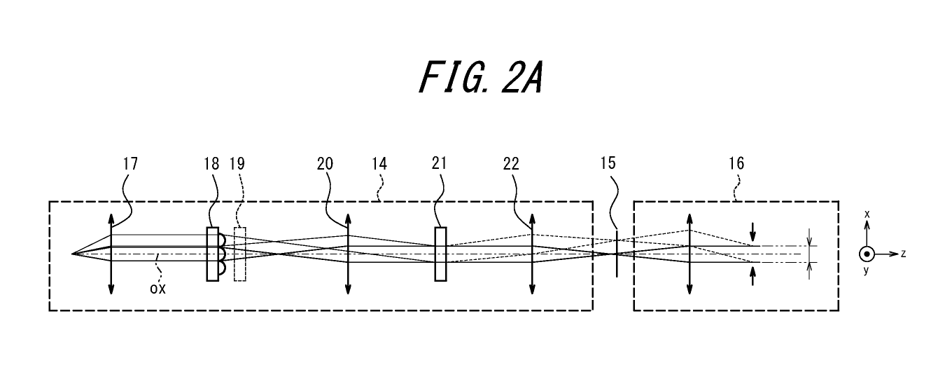

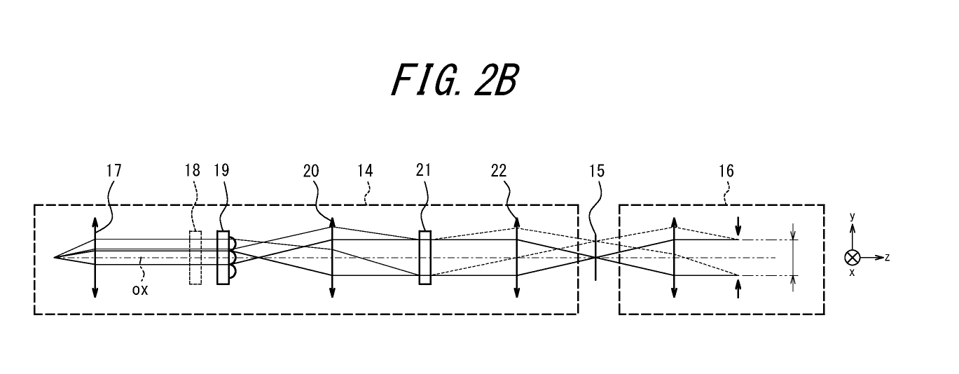

As illustrated in FIGS. 2A and 2B, the optical illumination system 14 includes a collimator lens 17, a first lenticular lens 18, a second lenticular lens 19, a first lens 20, a diffuser panel 21, and a second lens 22. The collimator lens 17, first lenticular lens 18, second lenticular lens 19, first lens 20, diffuser panel 21, and second lens 22 are optically joined. The collimator lens 17 converts the illumination light emitted from the light source 13 into parallel light.

The first lenticular lens 18 includes a plurality of lens elements with a shorter lens pitch than the width of the light beam of the illumination light exiting from the collimator lens 17, for example 0.1 mm to 0.5 mm, and is configured so that the entering parallel light beam extends across a plurality of lens elements. The first lenticular lens 18 has a refractive power in the x-direction and diffuses illumination light converted to a parallel light beam along the x-direction.

The second lenticular lens 19 has a shorter focal length than does the first lenticular lens 18. The focal lengths of the first lenticular lens 18 and of the second lenticular lens 19 may, for example, respectively be 1.6 mm and 0.8 mm. The second lenticular lens 19 is disposed so that the back focal positions of the first lenticular lens 18 and the second lenticular lens 19 substantially match. The second lenticular lens 19 includes a plurality of lens elements with a shorter lens pitch than the width of the light beam of the illumination light from the collimator lens 17, for example 0.1 mm to 0.5 mm, and is configured so that the entering parallel light beam extends across a plurality of lens elements. The second lenticular lens 19 has a refractive power in the y-direction and diffuses illumination light that was diffused in the x-direction along the y-direction. A lenticular lens with an angle of diffusion in the y-direction larger than the angle of diffusion in the x-direction of the first lenticular lens 18 is used as the second lenticular lens 19.

The first lens 20 is disposed so that the front focal position of the first lens 20 substantially matches the back focal positions of the first lenticular lens 18 and the second lenticular lens 19. The focal length of the first lens 20 may, for example, be 50 mm. Accordingly, the first lens 20 converts illumination light components emitted from the plurality of lenses of the second lenticular lens 19 into parallel light beams with different exit angles and emits the parallel light beams.

The diffuser panel 21 is disposed to match the back focal position of the first lens 20 substantially. Accordingly, the plurality of parallel light beams emitted from the first lens 20 irradiate the diffuser panel 21 in a convoluted state. As a result, a laser that has a Gaussian intensity distribution irradiates the diffuser panel 21 as illumination light that has an approximately uniform intensity distribution and is rectangular, with a wider light beam width in the y-direction than in the x-direction. The diffuser panel 21 is driven by a diffusion panel driving mechanism (not illustrated), vibrates in a plane perpendicular to the optical axis OX, and reduces the visibility of speckles. The diffuser panel 21 may, for example, be a holographic diffuser designed to have a rectangular diffusion angle and irradiates the entire area of the below-described rectangular transmissive chart 15, with a uniform intensity and without excess or deficiency, with illumination light emitted from the diffuser panel 21.

The second lens 22 is disposed so that the front focal position of the second lens 22 substantially matches the position of the diffuser panel 21. The focal length of the second lens 22 may, for example, be 26 mm. The second lens 22 focuses, at each angle, the illumination light that is incident at a variety of angles.

The transmissive chart 15 constitutes a spatial light modulator and is disposed at the back focal position of the second lens 22. The transmissive chart 15 may, for example, be a rectangle with a length of 4.5 mm in the x-direction and a length of 5.6 mm in the y-direction. The transmissive chart 15 is driven by a chart driver (not illustrated) and forms any image to be displayed by the display apparatus 10. The pixels constituting the image of the transmissive chart 15 are irradiated by the parallel light beams focused at respective angles. Accordingly, the light passing through the pixels constitutes image light.

The optical projection system 16 is disposed so that the exit pupil of the optical projection system 16 and the diffuser panel 21 are optically conjugate. Accordingly, the exit pupil has a rectangular shape that is longer in the y-direction than in the x-direction. The focal length of the optical projection system 16 is, for example, 28 mm, and the image light projected through the transmissive chart 15 is projected to infinity. As image light, the optical projection system 16 emits a group of parallel light beams having angular components in the x-direction and the y-direction corresponding to the position in the x-direction and the y-direction of the pixels of the transmissive chart 15, i.e. the object height from the optical axis OX. In this embodiment, for example the light beams exit in an angular range of ±4.6° in the x-direction and ±5.7° in the y-direction. The image light projected by the optical projection system 16 enters the pupil enlarging optical system 12.

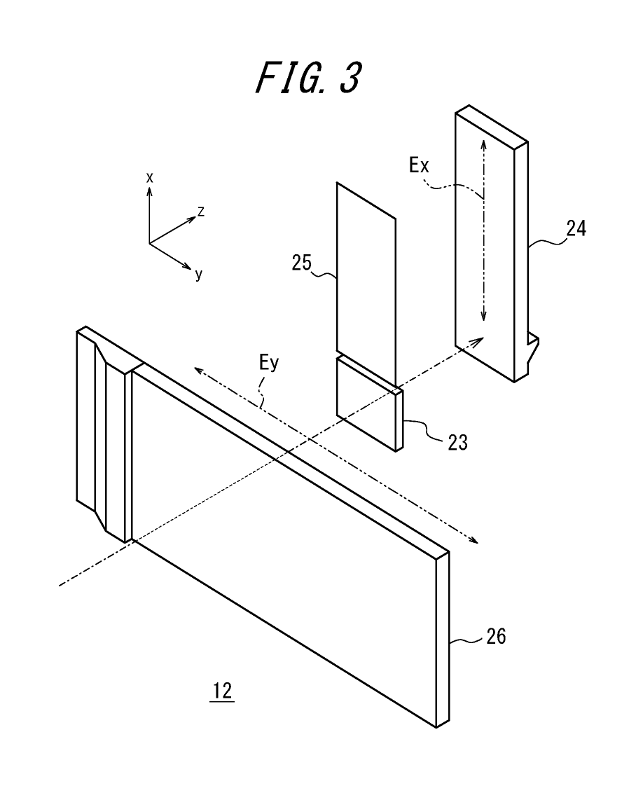

Next, the structure of the pupil enlarging optical system 12 is described with reference to FIG. 3. The pupil enlarging optical system 12 includes a polarizer 23, a first optical propagation system 24, a half-wavelength plate 25, and a second optical propagation system 26. In FIG. 3, for the sake of illustration, the polarizer 23, first optical propagation system 24, half-wavelength plate 25, and second optical propagation system 26 are displayed as being widely separated, but these components are actually arranged in close proximity, as illustrated in FIG. 1.

The polarizer 23 is disposed between the exit pupil of the optical projection system 16 and the first optical propagation system 24. Image light from the optical projection system 16 is incident on the polarizer 23, which emits s-polarized light. The first optical propagation system 24 is disposed so that the area of incidence (not illustrated in FIG. 3) of a second planar surface (not illustrated in FIG. 3) of the below-described first light guide (not illustrated in FIG. 3) and the exit pupil of the optical projection system 16 are combined. The first optical propagation system 24 enlarges, in the x-direction, the exit pupil projected as s-polarized light by the polarizer 23 and emits the result (see reference sign “Ex”). The half-wavelength plate 25 rotates, by 90°, the polarization plane of the image light expanded in the x-direction. By rotating the polarization plane 90°, the image light can be caused to enter the first polarizing beam splitter film (not illustrated in FIG. 3) of the second optical propagation system 26 as s-polarized light. The second optical propagation system 26 expands the image light, the polarization plane of which was rotated by the half-wavelength plate 25, in the y-direction and emits the result (see reference sign “Ey”).

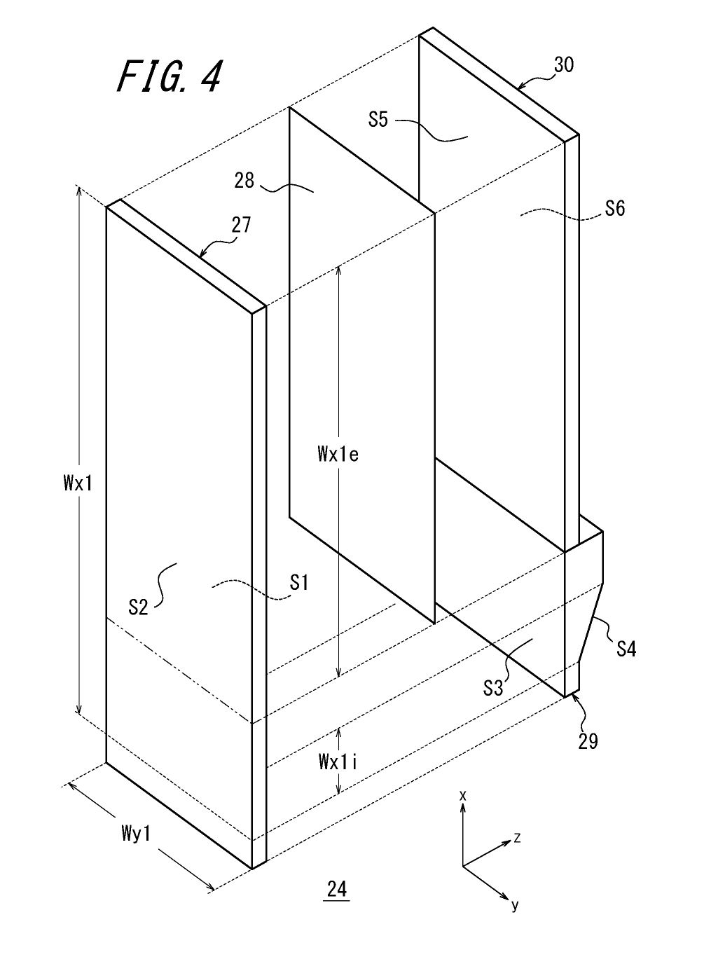

Next, the function by which the first optical propagation system 24 expands the exit pupil is described along with the structure of the first optical propagation system 24. As illustrated in FIG. 4, the first optical propagation system 24 includes a first light guide 27, a first polarizing beam splitter film 28, a first input deflector 29, and a first output deflector 30. The first polarizing beam splitter film 28 is vapor deposited on the first light guide 27, as described below, and cannot be separated from the first light guide 27, but these components are illustrated schematically in FIG. 4 as being separated.

The first light guide 27 is a flat plate with transmittivity having a first planar surface S1 and a second planar surface S2 that are parallel and oppose each other. The first input deflector 29 is a prism that has a planar input side bonded surface S3 and an inclined surface S4 that is inclined relative to the input side bonded surface S3. The first output deflector 30 is a plate-shaped member with transmittivity, the plate surfaces of which are an output side bonded surface S5, and on the back side, a triangular prism array surface S6 on which a triangular prism array is formed.

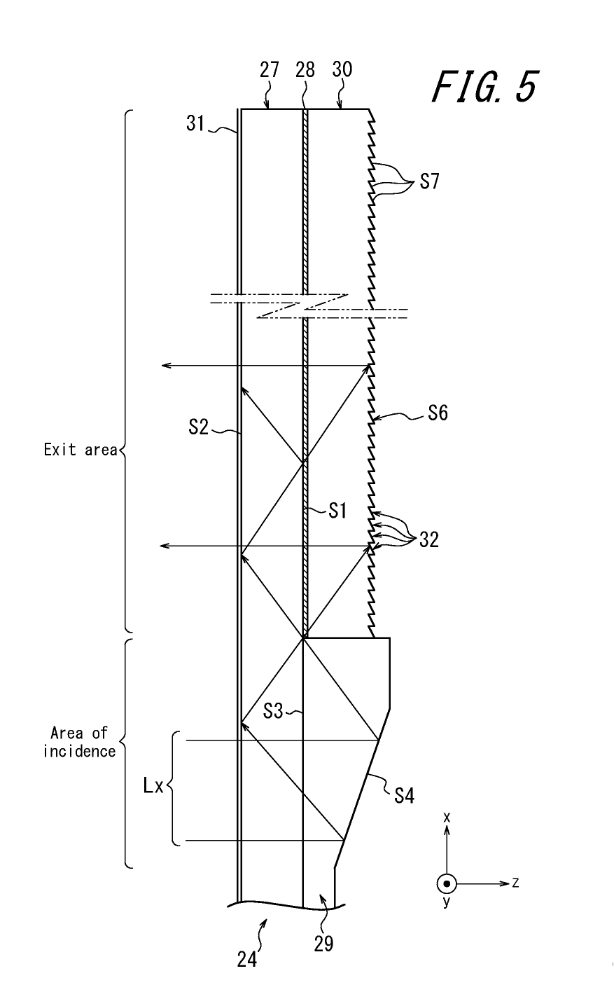

In a partial area of the first planar surface S1 of the first light guide 27, the first polarizing beam splitter film 28 is formed by vapor deposition to have substantially the same size as the output side bonded surface S5 of the first output deflector 30. The first output deflector 30 is bonded at the output side bonded surface S5 by transparent adhesive to the area of the first planar surface S1 in which the first polarizing beam splitter film 28 is formed. The first input deflector 29 is bonded at the input side bonded surface S3 by transparent adhesive to the area of the first planar surface S1 other than the area in which the first polarizing beam splitter film 28 is formed. The first optical propagation system 24 is integrated by the first light guide 27 being bonded to the first output deflector 30 and the first input deflector 29. Hereinafter, in the longitudinal direction of the first optical propagation system 24 (the “x-direction” in FIG. 4), the area in which the first input deflector 29 is provided is referred to as the area of incidence, and the area in which the first output deflector 30 is provided is referred to as the exit area (see FIG. 5). As described below, the first polarizing beam splitter film 28 is preferably formed so as to enter slightly into the area of incidence.

The integrated first optical propagation system 24 is a flat plate, and the lengths Wx1 and Wy1 respectively in the length direction (the “x-direction” in FIG. 4) and the width direction (the “y-direction” in FIG. 4) of the first optical propagation system 24 and the first light guide 27 may, for example, be 60 mm and 20 mm. The length Wx1e of the first polarizing beam splitter film 28 in the longitudinal direction may, for example, be 50 mm. The length Wx1i of the first input deflector 29 in the longitudinal direction may, for example, be 7 mm. As illustrated in FIG. 4, the first input deflector 29 may include a section with a surface other than the inclined surface S4 as a surface that faces the input side bonded surface S3, but the length Wx1i of the first input deflector 29 in the longitudinal direction is the length of the inclined surface S4 in the longitudinal direction.

The first polarizing beam splitter film 28 is a multilayer film designed to transmit light that enters from a substantially perpendicular direction while reflecting the majority and transmitting the remainder of light that enters obliquely. A thin film with low-pass or band-pass type spectral reflectance may exhibit such properties.

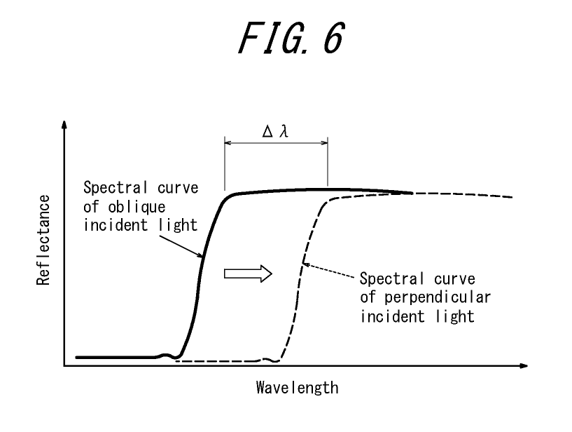

As is known, the spectral curve shifts in the wavelength direction in accordance with the angle of incidence on a thin film. As illustrated in FIG. 6, the spectral curve (see the dashed line) with respect to approximately perpendicular incident light shifts in the longer wavelength direction from the spectral curve with respect to oblique incident light (see the solid line). The first polarizing beam splitter film 28 can be formed by combining the wavelength of the incident light beam Lx and the settings of the thin film so as to be sandwiched between the cutoff wavelengths of the spectral curve with respect to oblique incident light and the spectral curve with respect to approximately perpendicular incident light and so that the reflectance with respect to oblique incident light is 95% and the reflectance with respect to approximately perpendicular incident light is 0%.

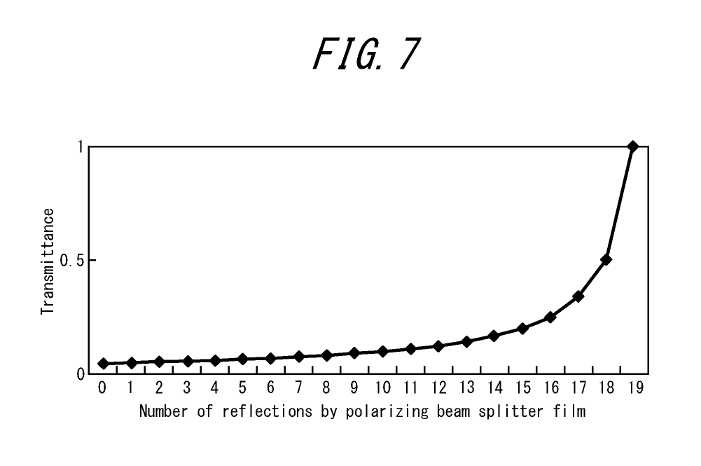

The first polarizing beam splitter film 28 has transmittance, with respect to oblique incident light, that changes in accordance with position along the x-direction. For example, the first polarizing beam splitter film 28 is formed so that the transmittance increases as a geometric progression (see FIG. 7) in accordance with distance from one end of the first polarizing beam splitter film 28 at the first input deflector 29 side. Such a film may be formed by vapor deposition by, for example, designing the process in advance so that the distance from the vapor deposition source changes in accordance with planar distance from the first input deflector 29, so as to yield desired reflectance properties at each position in accordance with the difference in distance (difference in thickness of the film that is formed).

Synthetic quartz (a transparent medium) for example having a thickness, i.e. a length in the z-direction, of 2 mm may be used as the first light guide 27 (see FIG. 4). Using synthetic quartz is advantageous in that the first light guide 27 has heat resistance with respect to heating when the first polarizing beam splitter film 28 is vapor deposited and does not warp easily under film stress, since synthetic quartz is a hard material.

An antireflection (AR) film 31 is formed on the second planar surface S2 of the first light guide 27. The AR film 31 suppresses reflectance of image light entering from the perpendicular direction. The AR film 31 is designed and formed so that the film stress thereof matches the film stress of the first polarizing beam splitter film 28. By causing the film stress to match, warping of the first optical propagation system 24 can be suppressed, contributing to good propagation of image light.

The first input deflector 29 is, for example, formed from synthetic quartz. By forming the first input deflector 29 from synthetic quartz, i.e. the same material as the first light guide 27, the reflectance at the interface between the input side bonded surface S3 and the first planar surface S1 can be reduced ideally.

Aluminum is vapor deposited on the inclined surface S4 of the first input deflector 29 and functions as a reflecting film. As illustrated in FIG. 5, a normal line to the inclined surface S4 extends to the exit area side of the first light guide 27. Accordingly, a light beam incident perpendicularly on the second planar surface S2 of the first light guide 27 in the area of incidence is reflected by the inclined surface S4 inside the first input deflector 29 and propagates towards the exit area. The apex angle between the input side bonded surface S3 and the inclined surface S4 is described below. The interface between the first input deflector 29 and the first output deflector 30 is colored black and absorbs the incident light beam without reflecting the light beam.

The first output deflector 30 is, for example, formed by acrylic having a thickness of 3 mm. The triangular prism array formed on the first output deflector 30 is minute and is formed by mold injection. Acrylic, which can be formed by mold injection and is a transparent medium, has thus been selected as an example. Aluminum is vapor deposited on the triangular prism array surface S6 and functions as a reflecting film. The first output deflector 30 is formed by acrylic in this embodiment but is not limited to being acrylic resin. However, when the first output deflector 30 is joined on a planar surface with a film having properties in one polarization direction, like the first polarizing beam splitter film 28, the material and formation conditions are preferably selected to allow suppression of occurrence of birefringence within the material.

On the triangular prism array surface S6 of the first output deflector 30, a plurality of triangular prisms 32 extending in the y-direction are formed. The triangular prisms 32 are aligned in the x-direction in saw-toothed fashion with a pitch of, for example, 0.9 mm.

The inclination angle of an inclined surface S7 of each triangular prism 32 relative to the output side bonded surface S5 is opposite from the inclination of the inclined surface S4 of the first input deflector 29, i.e. a normal line to the inclined surface S7 extends to the area of incidence side of the first light guide 27. The absolute value of the inclination angle of each triangular prism 32 is substantially equal to the inclination angle of the inclined surface S4 or differs over a range of a few degrees in accordance with the combination of materials used for the first input deflector 29, the first light guide 27, and the first output deflector 30. The difference in angle between adjacent prisms on the triangular prism array surface S6 is approximately 0.01° (0.5 min) or less.

The apex angle between the input side bonded surface S3 and the inclined surface S4 of the first input deflector 29 and the inclination angle of the triangular prisms 32 is determined based on the critical angle at the second planar surface S2 of the first light guide 27, as described below.

The first optical propagation system 24 is disposed so that a light beam Lx parallel to the optical axis OX of the optical image projection system 11 is incident from the outside perpendicularly on the area of incidence at the second planar surface S2. The light beam Lx incident perpendicularly on the area of incidence enters the first input deflector 29 from the first light guide 27 and is reflected diagonally by the inclined surface S4. The diagonally reflected light beam Lx passes through the inside of the first light guide 27 and is incident on the second planar surface S2. The apex angle between the input side bonded surface S3 and the inclined surface S4 of the first input deflector 29 and the inclination angle of the triangular prism 32 are determined so that the light beam Lx incident on the second planar surface S2 in the first light guide 27 is totally reflected.

Accordingly, the angle of incidence θ relative to the second planar surface S2 in the first light guide 27 needs to exceed the critical angle, i.e. the relationship θ>critical angle=sin⁻¹(1/n) (where n is the refractive index of the first light guide 27) needs to hold. In this embodiment, the first light guide 27 is formed from synthetic quartz as described above, and therefore the critical angle is 43.6°.

With regard to the light beam at the object height that is incident perpendicularly from the optical image projection system 11, the angle of incidence θ on the second planar surface S2 inside the first light guide 27 is twice the inclination angle of the inclined surface S4 relative to the input side bonded surface S3 of the first input deflector 29. Hence, the inclination angle needs to be at least 21.8°. In this embodiment, the inclination angle is 25.8°, for example, which is at least 21.8°. The inclination angle of each triangular prism 32 is, for example, 25°.

Based on the size of the transmissive chart 15 and the focal length of the optical projection system 16, the angle of the light ray incident on the area of incidence of the second planar surface S2 can be restricted. For example, the angle of the incident light ray can be restricted to be within a range of ±4.6° in the x-direction and ±5.7° in the y-direction on the air side and within a range of ±3.1° in the x-direction and ±3.9° in the y-direction in the medium of the first light guide 27 formed from synthetic quartz. With such an angle restriction, the light beam at the angle of image light corresponding to all object heights can be totally reflected at the second planar surface S2 within the first light guide 27 in the above-described first optical propagation system 24.

In the first optical propagation system 24 structured and arranged as described above, the light beam Lx incident perpendicularly on the area of incidence of the second planar surface S2 is reflected at the inclined surface S4 of the first input deflector 29 and is incident diagonally on the exit area of the second planar surface S2 inside the first light guide 27. A light beam Lx incident diagonally is incident on the second planar surface S2 at an angle exceeding the critical angle and is totally reflected. In other words, by being incident from a medium with a larger refractive index to a medium with a smaller refractive index at an angle of incidence exceeding the critical angle, the light beam Lx does not pass through the second planar surface S2 at the interface, but rather is totally reflected. The totally reflected light beam Lx is incident diagonally on the first polarizing beam splitter film 28. Only a predetermined percentage of light is transmitted, and the remainder of the light is reflected. The light beam Lx reflected at the first polarizing beam splitter film 28 is incident again on the second planar surface S2 at an angle exceeding the critical angle and is totally reflected. Subsequently, the light beam Lx propagates in the x-direction of the first light guide 27 while repeatedly being partially reflected at the first polarizing beam splitter film 28 and totally reflected at the second planar surface S2. Each time the light beam Lx is incident on the first polarizing beam splitter film 28, however, a predetermined percentage of the light beam Lx is transmitted and is incident on the first output deflector 30.

The light beam Lx incident on the first output deflector 30 is once again deflected by the reflecting film on the inclined surface S7 of the triangular prism 32 in a direction perpendicular to the second planar surface S2 of the first light guide 27. The light beam Lx deflected in the perpendicular direction passes through the first polarizing beam splitter film 28 at a transmittance of substantially 100% and exits to the outside from the second planar surface S2. Accordingly, in the first optical propagation system 24, the light beam extractor is configured to include the first polarizing beam splitter film 28 and the first output deflector 30.

The half-wavelength plate 25 (see FIG. 3) is formed into a shape substantially the same size as the exit area of the second planar surface S2. The half-wavelength plate 25 is disposed at a position opposite the exit area of the second planar surface S2, with a gap therebetween. Accordingly, the light beam obliquely incident on the second planar surface S2 in the first light guide 27 does not pass through the second planar surface S2, but rather total reflection is guaranteed. As described above, the half-wavelength plate 25 rotates the polarization plane of the light beam emitted from the first optical propagation system 24 by 90°.

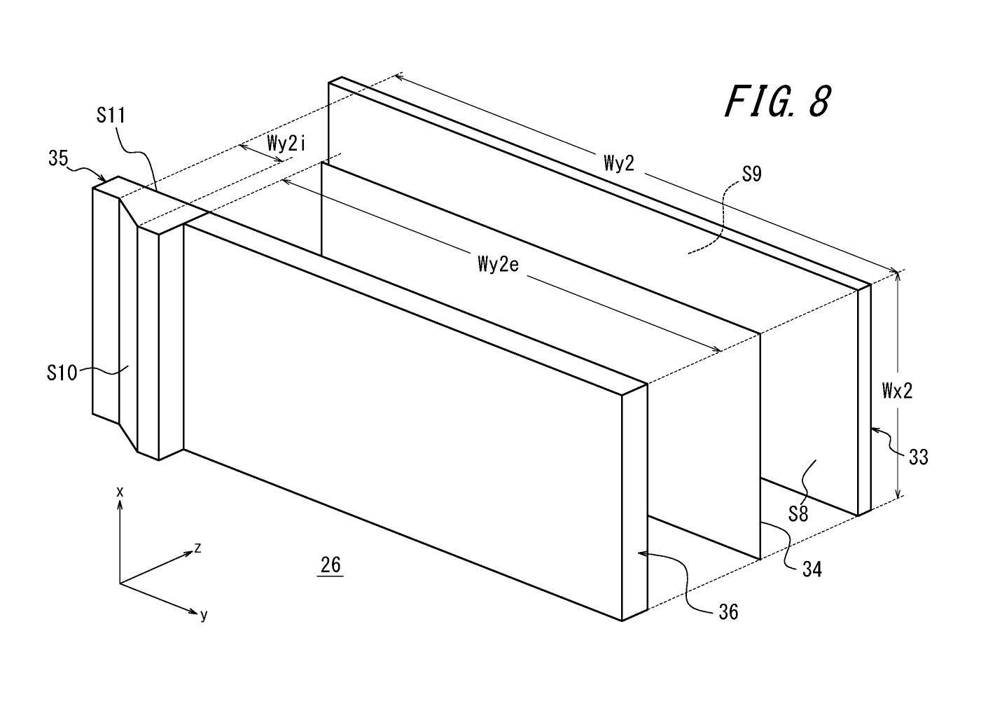

The structure of the second optical propagation system 26 other than the size and the arrangement thereof is the same as that of the first optical propagation system 24. As illustrated in FIG. 8, the second optical propagation system 26 includes a second light guide 33, a second polarizing beam splitter film 34, a second input deflector 35, and a second output deflector 36. Like the first optical propagation system 24, these constituent members are in the shape of an integrated flat plate, and the lengths Wx2 and Wy2 respectively in the width direction (the “x-direction” in FIG. 8) and the length direction (the “y-direction” in FIG. 8) of the second optical propagation system 26 and the second light guide 33 may, for example, be 50 mm and 110 mm. The length Wy2e of the second polarizing beam splitter film 34 in the longitudinal direction in the second optical propagation system 26 may, for example, be 100 mm. The length Wy2i of the second input deflector 35 in the longitudinal direction may, for example, be 10 mm. The second light guide 33, second polarizing beam splitter film 34, second input deflector 35, and second output deflector 36 are respectively similar in function to the first light guide 27, first polarizing beam splitter film 28, first input deflector 29, and first output deflector 30.

The second light guide 33 includes a third planar surface S8, on which the second polarizing beam splitter film 34 is vapor deposited, and a fourth planar surface S9 opposing the third planar surface S8. The fourth planar surface S9 is the observer-side surface. The second optical propagation system 26 is disposed so that the exit area of the second planar surface S2 of the first optical propagation system 24 and the area of incidence of the fourth planar surface S9 of the second optical propagation system 26 face each other, and so that the second optical propagation system 26 is rotated 90° with respect to the first optical propagation system 24 about an axis that is a line parallel to the z-direction (see FIG. 3). Accordingly, in the second optical propagation system 26, the light beam extractor is configured to include the second polarizing beam splitter film 34 and the second output deflector 36. The second optical propagation system 26 enlarges, in the y-direction, the exit pupil of the image light emitted from the first optical propagation system 24 and emits the image light from the projection area PA of the fourth planar surface S9, which is the observer-side surface of the second light guide 33.

In the first optical propagation system 24, the AR film 31 on the second planar surface S2 of the first light guide 27 may be omitted. Similarly, in the second optical propagation system 26, the AR film on the fourth planar surface S9 of the second light guide 33 may be omitted.

In FIG. 1, the optical image projection system 11 and the pupil enlarging optical system 12 are stored within a housing of the display apparatus 10 so as to allow observation of the projection area PA from the outside. In this case, if the projection area PA, i.e. the fourth planar surface S9 of the second light guide 33, is directly exposed to the outside, the quality of the observed image degrades as described above due to a fingerprint, a water drop, or the like adhering to the second light guide 33. To address this issue, the display apparatus 10 according to this embodiment includes a parallel flat plate 50 disposed facing the fourth planar surface S9 of the second light guide 33.

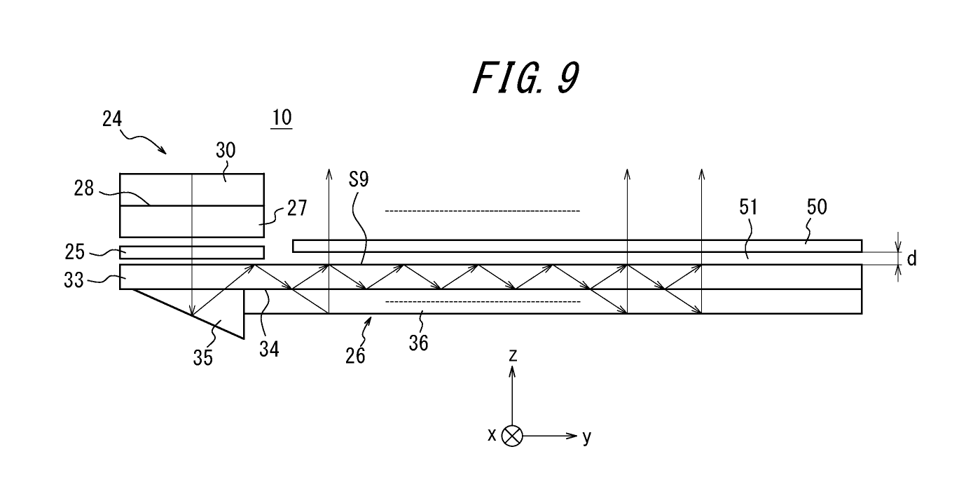

The parallel flat plate 50 constitutes a window member and is disposed facing the second light guide 33 with a gap 51 therebetween, as illustrated in FIG. 9. The parallel flat plate 50 is a material transparent or semi-transparent with respect to visible light, such as synthetic quartz, glass, tempered glass, a plastic such as acrylic, or the like. The parallel flat plate 50 is formed to a thickness of, for example, approximately 1 mm considering factors such as strength.

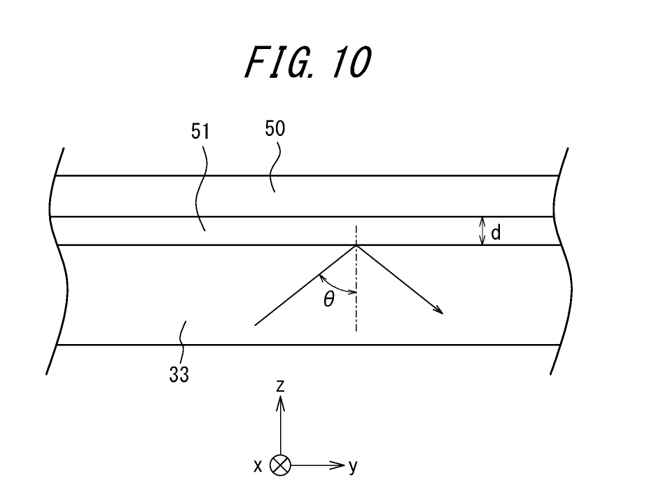

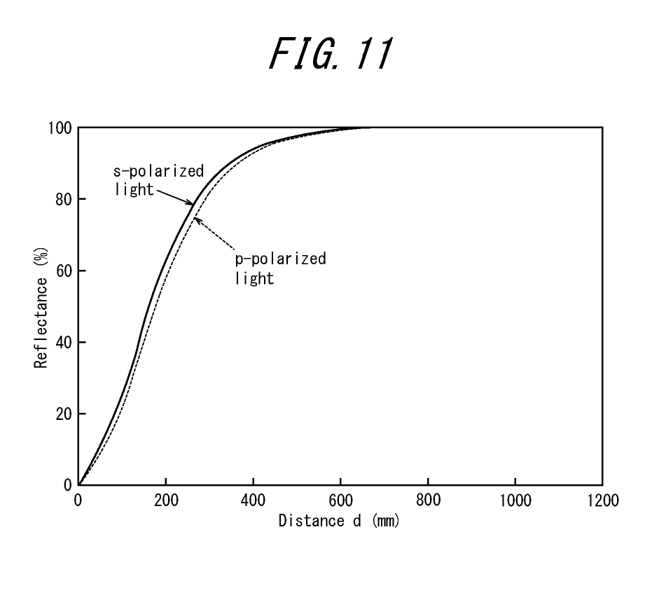

The gap 51 may be a gas such as air, nitrogen, or the like, or may be a vacuum. The distance d of the gap 51, i.e. the distance d between the second light guide 33 and the parallel flat plate 50, is determined by taking into consideration that if the distance d is too narrow, evanescent light is generated towards the parallel flat plate 50, lowering the reflectance under the condition of total reflection in the second light guide 33, whereas if the distance d is too large, the apparatus increases in size. The results of simulating the reflectance as a function of the distance d are illustrated in FIG. 11 for the case of the angle of incidence θ of image light on the fourth planar surface S9 in the second light guide 33 being 51.6°, the wavelength of the image light being 700 nm, the refractive index of the second light guide 33 being 1.45, and the gap 51 being an air layer, for example, as illustrated in FIG. 10.

As is clear from FIG. 11, the reflectance reaches 100% for both p-polarized light and s-polarized light if the distance d is 700 nm or greater. In other words, the distance d at which the reflectance reaches 100% is one wavelength or greater of light having a wavelength of 700 nm. In the case of visible light, light with a wavelength of 700 nm is in the longest wavelength band in use. Therefore, the distance d is preferably 700 nm or greater. On the other hand, if the distance d is too large, the thickness of the apparatus increases, causing the apparatus to increase in size. Hence, the distance d is preferably 1 mm or less. The parallel flat plate 50 does not need to be parallel to the fourth planar surface S9. In the case of not being parallel, the distance d varies by position along the parallel flat plate 50.

According to the display apparatus 10 of this embodiment, the window member constituted by the parallel flat plate 50 is disposed facing the second light guide 33 with the gap 51 therebetween. Therefore, adherence of oil from a fingerprint or the like due to a hand contacting the fourth planar surface S9, which is the observer-side surface of the second light guide 33, can reliably be prevented, as can the adherence of a water drop such as a raindrop when the display apparatus is used outdoors in the rain. An image due to the transmissive chart 15 can thus be observed with good image quality.

In this embodiment, the parallel flat plate 50 is for example held by a window frame in the housing of the display apparatus 10, and the second optical propagation system 26 is fixed in the housing, so that the parallel flat plate 50 and the second light guide 33 face each other with the gap 51 of the distance d therebetween.

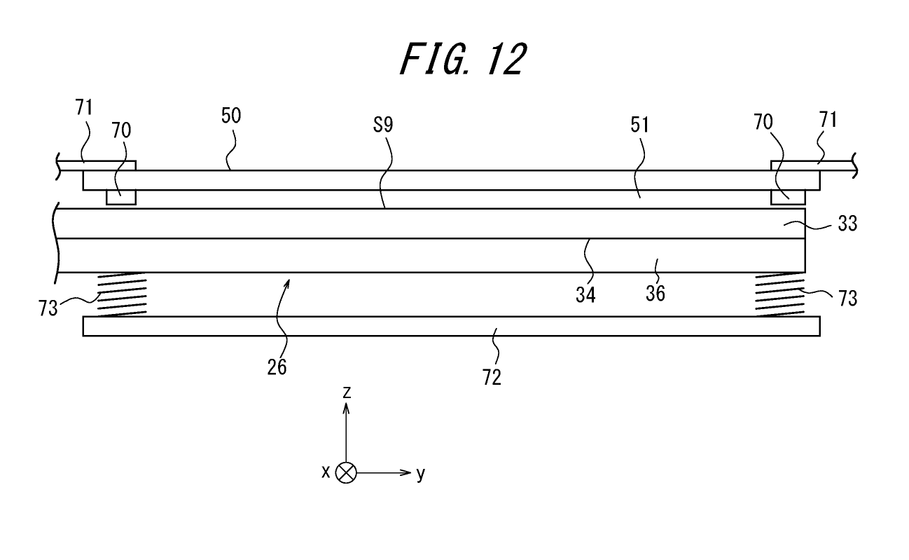

Alternatively, for example as illustrated by the partial schematic diagram of FIG. 12, the parallel flat plate 50 may be held on the fourth planar surface S9 of the second light guide 33 via spacers 70 that form the gap 51 of the distance d at a plurality of peripheral locations. In FIG. 12, the spacers 70 are preferably made of a metal such as brass or a plastic such as polyacetal and are fixed to the parallel flat plate 50 side by adhesive or the like. The surface of the spacers 70 at the second light guide 33 side is formed so as to be in point contact or line contact with the second light guide 33 at one or more points or lines. Alternatively, the surface of the spacers 70 at the second light guide 33 side may be formed to have a rough surface accuracy, for example so that the maximum valley depth Rv of the roughness curve is 0.6 μm or greater, which is a depth that encompasses green wavelengths to which the human eye is highly sensitive. The maximum valley depth Rv is preferably 0.7 μm or greater, which is a depth that encompasses the wavelengths of the visible light region.

The parallel flat plate 50 is, for example, fixed to a window frame 71 of the apparatus housing by adhesive or the like at the periphery of the observer-side surface. An elastic member 73, such as a spring, a leaf spring, rubber, a sponge, or the like is provided between the second output deflector 36 of the second optical propagation system 26 and a fixing member 72 and elastically presses the second optical propagation system 26 towards the parallel flat plate 50. As a result, the fourth planar surface S9 of the second light guide 33 is elastically pressed into contact with the spacers 70, and the fourth planar surface S9 of the second light guide 33 and the parallel flat plate 50 are disposed to face each other with the gap 51 of the distance d therebetween. So as not to deform under its own weight and so as not to deform greatly when touched by the observer's finger or the like, the parallel flat plate 50 preferably has a shear modulus of 1.0 GPa or greater. Due to having a small contact area with respect to the fourth planar surface S9, the spacers 70 may deform upon being made of a soft material, and the distance d may end up changing. Therefore, the spacers 70 preferably have a Rockwell hardness of R100 or greater.

With this configuration, the spacers 70 are in partial contact with the second light guide 33. Accordingly, by setting the interval between the second light guide 33 and the portion of each spacer 70 not in contact with the second light guide 33 for example to be equal to or greater than the wavelength of the image light, a reduction in the reflectance of image light at the portion of the spacers 70 in the second light guide 33 can be suppressed. As a result, defects and the like in the image can more reliably be prevented, allowing images to be observed with better image quality. Furthermore, since the parallel flat plate 50 is disposed by guaranteeing the gap 51 with the spacers 70 positioned in the projection area of the second light guide 33, the second light guide 33 and the parallel flat plate 50 can be made smaller, thereby making the apparatus more compact overall.

### Embodiment 2

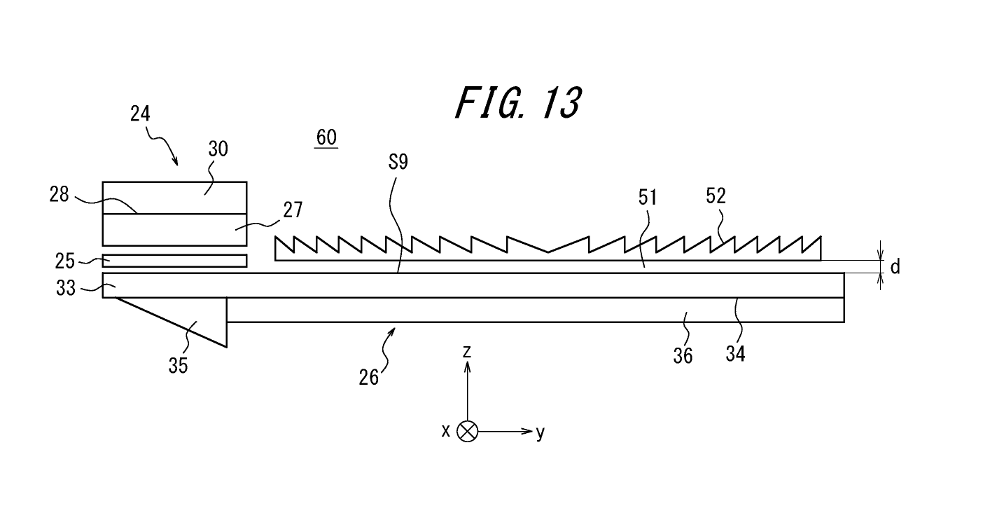

FIG. 13 illustrates the main structure of a display apparatus according to Embodiment 2. A display apparatus 60 according to this embodiment has the structure of the display apparatus 10 of Embodiment 1, except that the window member is formed by a Fresnel lens 52 that has a refractive power. Since the remaining structure is similar to that of Embodiment 1, identical constituent elements are labeled with the same reference signs, and a description thereof is omitted.

The Fresnel lens 52 is, for example, made of plastic such as acrylic and is held as described in Embodiment 1, so that the planar surface side faces the second light guide 33. As in Embodiment 1, the distance d of the gap 51 between the second light guide 33 and the Fresnel lens 52 is preferably 700 nm or greater to 1 mm or less.

By configuring the window member with the Fresnel lens 52, the display apparatus 60 of this embodiment has the advantage of not only achieving the effects of Embodiment 1, but also minimizing an increase in thickness of the window member, thereby minimizing an increase in size of the apparatus and allowing diopter adjustment by the observer.

### Embodiment 3

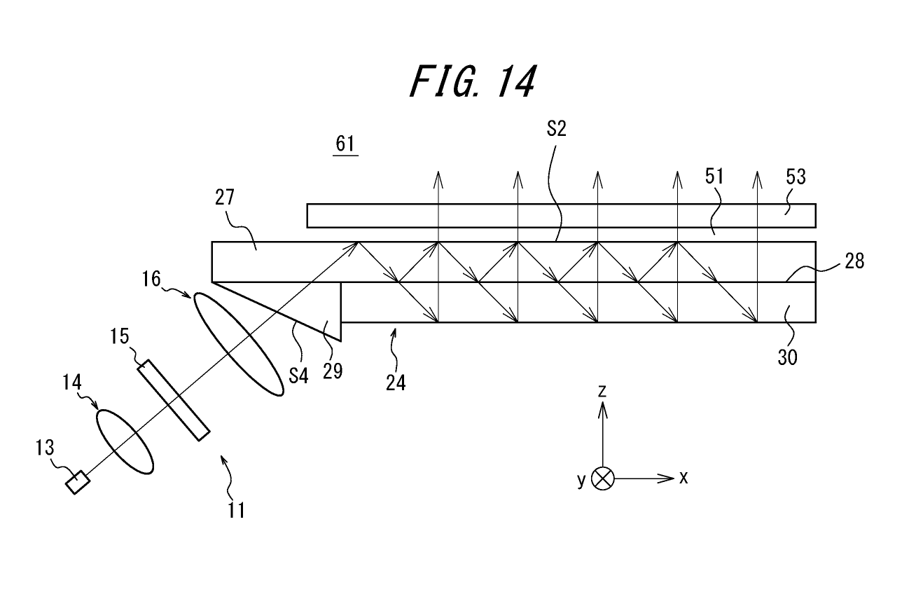

FIG. 14 schematically illustrates the main structure of a display apparatus according to Embodiment 3. A display apparatus 61 according to this embodiment has the same structure as the display apparatus 10 of Embodiment 1, except that the pupil enlarging optical system 12 is constituted by the first optical propagation system 24, omitting the polarizer 23, the half-wavelength plate 25, and the second optical propagation system 26. The differences from Embodiment 1 are described below. In the following explanation, the first optical propagation system 24 is referred to simply as an optical propagation system 24. Similarly, the constituent elements of the optical propagation system 24 are simply referred to as a light guide 27, polarizing beam splitter film 28, input deflector 29, and output deflector 30.

In the optical image projection system 11, image light from the outside is directly incident on the inclined surface S4 of the input deflector 29 in the optical propagation system 24. Accordingly, in this embodiment, a reflecting film is of course not formed on the inclined surface S4. The image light incident on the inclined surface S4 is incident on the second planar surface S2 in the light guide 27 at an angle exceeding the critical angle. The image light entering the light guide 27 is propagated in the x-direction while repeatedly undergoing total reflection in the light guide 27 and is emitted from the second planar surface S2, which is the observer-side surface, due to the effect of the polarizing beam splitter film 28 and the output deflector 30 that constitute the light beam extractor. As a result, the exit pupil of the optical image projection system 11 is expanded in the x-direction, and image light is emitted from the projection area of the second planar surface S2 of the light guide 27. In FIG. 14, illustration of the optical illumination system 14 and the optical projection system 16 is simplified in the optical image projection system 11.

The display apparatus 61 according to this embodiment includes a parallel flat plate 53 disposed facing the second planar surface S2 of the light guide 27 with the gap 51 therebetween. The parallel flat plate 53 constitutes the window member, and like the parallel flat plate 50 of Embodiment 1, is a material transparent or semi-transparent with respect to visible light, such as synthetic quartz, glass, tempered glass, a plastic such as acrylic, or the like. The parallel flat plate 53 is formed to a thickness of, for example, approximately 1 mm. Like the parallel flat plate 50 described in Embodiment 1, the parallel flat plate 53 is held in a housing of the display apparatus 61 that stores and holds the optical image projection system 11 and the pupil enlarging optical system 12, so that the projection area of the light guide 27 can be observed from the outside.

Accordingly, in the display apparatus 61 of this embodiment as well, like the display apparatus 10 of Embodiment 1, adherence of oil from a fingerprint or the like due to a hand contacting the projection area of the light guide 27 can reliably be prevented by the parallel flat plate 50, as can the adherence of a water drop such as a raindrop when the display apparatus is used outdoors in the rain. An image due to the transmissive chart 15 can thus be observed with good image quality.

### Embodiment 4

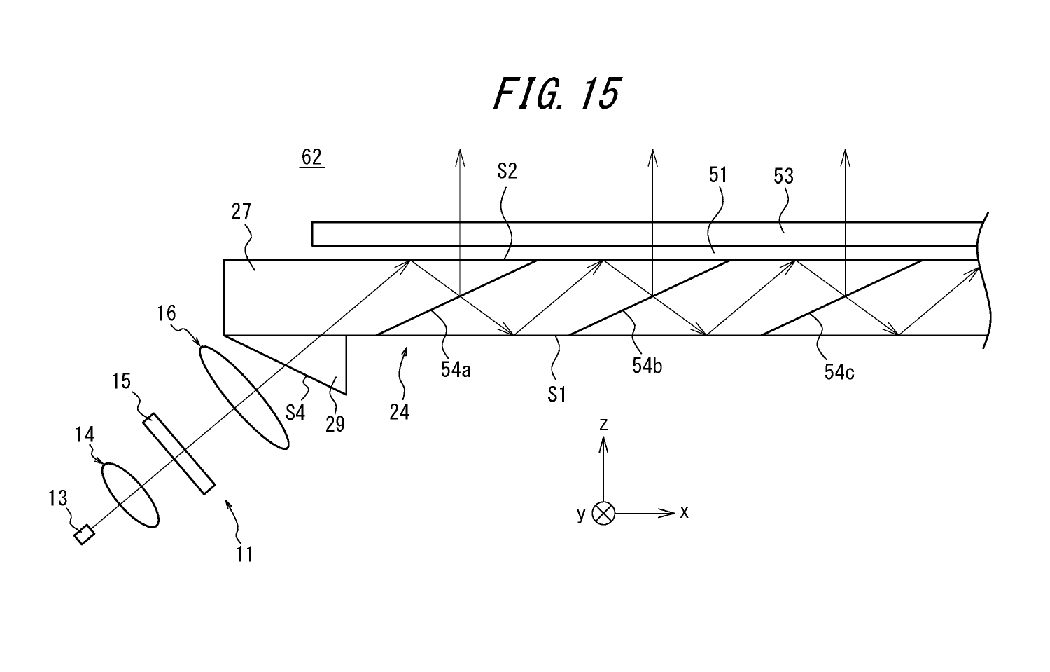

FIG. 15 schematically illustrates the main structure of a display apparatus according to Embodiment 4. A display apparatus 62 according to this embodiment has the structure of the display apparatus 61 of Embodiment 3, except that the light beam extractor of the optical propagation system 24 is configured differently. The differences from Embodiment 3 are described below.

Whereas the light extractor in Embodiment 3 is configured to include the polarizing beam splitter film 28 and the first output deflector 30, the light extractor in this embodiment is configured by providing a plurality of beam splitter films 54a, 54b, 54c, . . . along the x-direction in the light guide 27. The beam splitter films 54a, 54b, 54c, . . . are also collectively referred to below as beam splitter films 54. The beam splitter films 54 are formed at an inclination of 25° relative to the first planar surface S1 and the second planar surface S2 of the light guide 27.

In FIG. 15, image light that is incident on the second planar surface S2 in the light guide 27 from the inclined surface S4 of the input deflector 29 at an angle exceeding the critical angle is totally reflected at the second planar surface S2 and is incident on the beam splitter film 54a. A portion of the image light incident on the beam splitter film 54a is reflected, and the remainder is transmitted. The image light reflected at the beam splitter film 54a is emitted from the second planar surface S2 and passes through the parallel flat plate 53. The image light transmitted by the beam splitter film 54a is totally reflected at the first planar surface S1, is then totally reflected at the second planar surface S2, and is incident on the beam splitter film 54b. Subsequently, while similarly being separated into transmitted light and reflected light at the sequential beam splitter films 54, the image light propagates through the light guide 27 by the light transmitted at the beam splitter films 54 repeatedly undergoing total reflection at the first planar surface S1 and the second planar surface S2. The light reflected at the beam splitter films 54 is emitted from the second planar surface S2 and passes through the parallel flat plate 53.

Accordingly, in the display apparatus 62 of this embodiment as well, like the display apparatus 61 of Embodiment 3, adherence of oil from a fingerprint or the like due to a hand contacting the projection area of the light guide 27 can reliably be prevented by the parallel flat plate 53, as can the adherence of a water drop such as a raindrop when the display apparatus is used outdoors in the rain. An image due to the transmissive chart 15 can thus be observed with good image quality.

This disclosure is not limited to the above embodiments, and a variety of changes and modifications may be made. For example, in Embodiment 3 and Embodiment 4, instead of the parallel flat plate 53, a Fresnel lens may be the window member, as in Embodiment 2. Instead of a Fresnel lens, a liquid crystal lens in the shape of a flat plate may be used as the window member and may serve both to protect the projection area of the pupil enlarging optical system 12 and for diopter adjustment. Using a liquid crystal lens has the advantage of allowing continuous diopter adjustment by applied voltage.

Furthermore, any of an AR film, a fingerprint anti-adhesive film, and a water repellent film may be provided on the (observer-side) surface of the window member. For example, reflection of external light can be prevented by providing an AR film, the adherence of oil from a fingerprint or the like can be prevented by providing a fingerprint anti-adhesive film, and the adherence of water drops, such as rain, can be prevented by providing a water repellent film. Therefore, each of these layers can improve visibility.

Furthermore, in Embodiment 3 and Embodiment 4, in order to reduce the apparatus in size, the optical image projection system 11 may be provided with any layout. For example, in FIGS. 14 and 15, the light source 13, optical illumination system 14, transmissive chart 15, and optical projection system 16 may be disposed in the direction of extension of the optical propagation system 24, i.e. in the x-direction, below the output deflector 30, and image light emitted from the optical projection system 16 may be suitably reflected by a reflecting member so as to be incident on the inclined surface S4 of the input deflector 29. In each of the above-described embodiments, the optical image projection system 11 may be configured to cause image light to be incident on the pupil enlarging optical system 12 by, for example, using a scan mirror to perform a raster scan with a light beam from a laser light source. In Embodiments 1 to 3, the light extractor may be configured to use a grating instead of a triangular prism array.

1. A display apparatus comprising:
a light guide configured to propagate image light while totally reflecting the image light;
an optical system configured to introduce the image light into the light guide;
a light beam extractor configured to emit the image light propagating in the light guide from an observer-side surface of the light guide along an extent of propagation of the image light; and
a window member facing the observer-side surface of the light guide with a gap therebetween.

2. The display apparatus of claim 1, wherein the gap is 700 nm or greater to 1 mm or less.

3. The display apparatus of claim 1, wherein the window member is formed by a parallel flat plate.

4. The display apparatus of claim 1, wherein the window member has a refractive power.

5. The display apparatus of claim 1, wherein the window member comprises an AR film.

6. The display apparatus of claim 1, wherein the window member comprises a fingerprint anti-adhesive film.

7. The display apparatus of claim 1, wherein the window member comprises a water repellent film.

8. The display apparatus of claim 1, further comprising:
a plurality of spacers disposed between the light guide and the window member at a periphery of the light guide, wherein
the light guide is pressed elastically to the spacers.

9. The display apparatus of claim 8, wherein the spacers are partially in point contact or line contact with the light guide.

10. The display apparatus of claim 8, wherein the spacers have a surface roughness Rv of 0.6 μm or greater at the light guide side of the spacers.

11. The display apparatus of claim 8, wherein the spacers are made of metal.

12. The display apparatus of claim 8, wherein the spacers are made of plastic.
